(19) United States
(12) Patent Application Publication
(10) Pub. No.: US 2004/0045610 A1
(43) Pub. Date: Mar. 11, 2004

(54) Liquid distributor

(76) Inventors: Franz-Josef Carduck, Haan (DE); Theo Fleckenstein, Hilden (DE); Gerd Goebel, Koeln (DE); Roland Hourticolon, Leichlingen (DE)

Correspondence Address: COGNIS CORPORATION, PATENT DEPARTMENT, 300 BROOKSIDE AVENUE, AMBLER, PA, 19002, US

(21) Appl. No.: 09/855,002

(22) Filed: May 14, 2001

Related U.S. Application Data
(63) Continuation of application No. 09/277,399, filed on Mar. 26, 1999, now abandoned.
Application No. 09/277,399 is a continuation of application No. 08/674,698, filed on Jul. 9, 1996, now abandoned.
(60) Provisional application No. 60/001,211, filed on Jul. 18, 1995.

(51) Int. Cl. F17D 1/00

(52) U.S. Cl. 137/561 A

(57) ABSTRACT

The invention relates to a liquid distributor in the form of a channel distributor with drainage outlets. To ensure that the uniformity of distribution of the liquid is largely independent of disturbance factors, for example blockages of the drainage outlets, the drainage outlets are in the form of drainage pipes having a cross-section which tapers in the shape of a nozzle. The inner wall of the nozzle-like tapering of the drainage outlets being made of plastic, or another material resistant to the adherence of solids which would block the flow of liquid through the outlet.

### CROSS REFERENCE TO RELATED APPLICATIONS

This application claims the benefit of earlier filed provisional application serial No. 60/001,211 filed on Jul. 18, 1995 and application Ser. No. 08/674,698 filed Jul. 9, 1996, the entire contents of which are herein incorporated by reference.

### BACKGROUND OF THE INVENTION

1. Field of the Invention

This invention relates to a liquid distributor, preferably for a substantially vertical reactor containing a fixed catalyst bed, more particularly a tube-bundle reactor, the distributor being in the form of a channel distributor with drainage outlets.

2. Description of the Related Art

Liquid distributors of the type in question are used for material and heat exchange columns on the one hand and for reactors on the other hand and are intended to distribute the liquid over the packings or fixed beds arranged in the columns or reactors. In both cases, an important requirement is uniformity of distribution over the entire cross-section of the reactor or column independently of the load and a possible sloping position. More particularly, the efficiency of industrial trickle-bed reactors is influenced by the liquid distribution system. A uniform distribution of the liquid over the cross-section of the reactor guarantees adequate contact between the catalyst and the liquid phase and is therefore critical to the optimal operation of the reactor. If the volume of liquid is locally reduced by uneven distribution, performance is affected and has to be restored by an increase in temperature. However, this measure leads to losses of selectivity, to residue formation, to deposits and to caking of the catalyst. The outcome of this is failure of part of the catalyst packing. Since, in this case, the pressure loss in the packing increases beyond permitted limits despite high activity, the service life of the catalyst is reduced. Tube-bundle reactors in particular require a highly uniform distribution of the liquid to the individual tubes because any low-load regions are far more difficult to compensate with more heavily loaded regions than in shaft reactors.

One of the main causes of uneven liquid distribution is the blockage of the drainage outlets by soil particles present in the liquid. Other causes are the different distances of the drainage outlets from the point of introduction of the liquid, non-horizontal alignment of the distributor and variations as a function of time both in pressure and in the liquid flow rate on entry.

The problem addressed by the present invention was to provide a liquid distributor of the type mentioned at the beginning in which the uniformity of distribution of the liquid would be largely unaffected by the factors mentioned.

### SUMMARY OF THE INVENTION

According to the invention, the solution to this problem is characterized in that the drainage outlets in the form of drainage pipes have a cross-section—particularly at the upper end of the drainage pipe—which tapers in the shape of a nozzle with an inner wall preferably made of plastic, more particularly PTFE (polytetrafluoroethylene). However, the nozzle material may also consist of metal, ceramic, graphite, etc. By virtue of this special shape and also the special material at the narrowest point of the drainage pipe, the drainage pipe as a whole remains free from soil in the form of decomposition products on the inner walls which could affect the uniformity of distribution of the liquid through variation of the flow cross-section. Even after prolonged operation, no caking was observed on the inner walls of the drainage pipes as in other distribution systems.

According to the invention, the stream of liquid does not flow down the inner walls of the lower part of the drainage pipe, but instead freely downwards so that soil does not adhere, i.e. there is no reduction in cross-section which would ultimately result in blockage of the drainage pipe. The choice of the special material for the nozzle ensures that cracking products do not adhere to the inner walls of the nozzle.

In order even better to solve the problem of blockages by soil present in the liquid, one particular embodiment of the invention is characterized in that the drainage pipes extend upwards from the bottom of the distributor and comprise inlet openings arranged above the bottom of the distributor. In upwardly extending drainage pipes such as these according to EP 207 547 B1, soil can collect as sludge at the bottom of the distributor without flowing off through the inlet openings of the drainage pipes. If, therefore, the soil cakes on the bottom of the distributor, it does not affect the uniformity of distribution of the liquid.

The measure described above applies in particular to soil which is heavier than the liquid. However, in order to prevent distribution of the liquid from being affected by foreign substances which are lighter than the liquid and which therefore float on the surface, another embodiment of the invention is characterized by a hood with at least one opening which covers the inlet openings of the drainage pipe against the direct inflow of liquid.

In another advantageous embodiment of the invention, one of the openings of the hood is in the form of a horizontally encircling annular gap. The large cross-section thus obtained provides for minimal flow resistance and, at the same time, for the effective retention of soil.

In addition, to secure the hood and to retain in particular filament-like soil, the annular gap is interrupted by webs between the upper and lower part of the hood.

The overall opening diameter of the hood is increased by bores—acting as openings—arranged in a horizontally encircling line in the hood to retain soil particles. In addition, it has proved to be favorable to provide at least one bore acting as an opening in the top of the hood.

In order more effectively to retain soil particles, the space enclosed by the hood is divided up by an annular inner wall with openings arranged on the inside of the hood and the inlet of the drainage pipe is situated in the inner compartment of this space.

The nozzle is readily held on the inlet of the drainage pipe if the nozzle-like taper of the cross-section of the drainage pipe is formed by a plastic insert arranged in the drainage pipe of which the upper edge is held in position by the inner wall of the hood.

Another embodiment of the invention is characterized by an external screwthread on the drainage pipe by which the drainage pipe is screwed on the one hand to the bottom of the distributor and on the other hand to the hood. The hood and the drainage pipe are thus easy to disconnect from one another for cleaning, the screwthread mentioned being used both to screw the drainage pipe into the bottom of the distributor channel and to secure the hood to the drainage pipe.

The problem of channel distributors in particular is that their overall height is relatively large. In order to achieve particularly uniform distribution of the liquid, a preliminary distributor arranged above the main distributor is often provided. In order nevertheless to keep the overall height of the distributor system low and, at the same time, to be able to use the advantageous drainage pipes mentioned above, another embodiment of the invention is characterized by a preliminary distributor which is fitted into the main channel and of which the base extends over the drainage pipes in the form of domes.

A further embodiment of the invention is characterized by a sieve inserted into the preliminary distributor between the inlet and outlet as a further measure to retain the soil particles present in the liquid.

The distributor mentioned is particularly suitable for the hydrogenation of native oils, fats, fatty acids or fatty acid esters, preferably fatty acid methyl esters, more particularly in a tube-bundle reactor.

### BRIEF DESCRIPTION OF THE DRAWINGS

FIG. 1 is a plan view of a liquid distributor with a preliminary distributor of conventional design which is suitable for the installation of the drainage outlets according to the invention.

FIG. 2 is a section on the line A-B of FIG. 1 through the main channel of the distributor.

FIG. 3 is a section on the line C-D of FIG. 1.

FIG. 4 is a section through a side channel with a drainage pipe according to the invention.

FIG. 5 is the same sectional view as FIG. 4, but with a different construction of the drainage outlet.

FIG. 6 is the same sectional view as FIG. 4, but with another, particularly preferred construction of the drainage outlet.

FIG. 7 shows the two elements of the drainage outlet according to FIG. 6, namely the hood and the drainage pipe, in separate views.

### DETAILED DESCRIPTION OF THE INVENTION

Examples of embodiment of the invention are described in detail hereinafter with reference to the accompanying drawings, wherein:

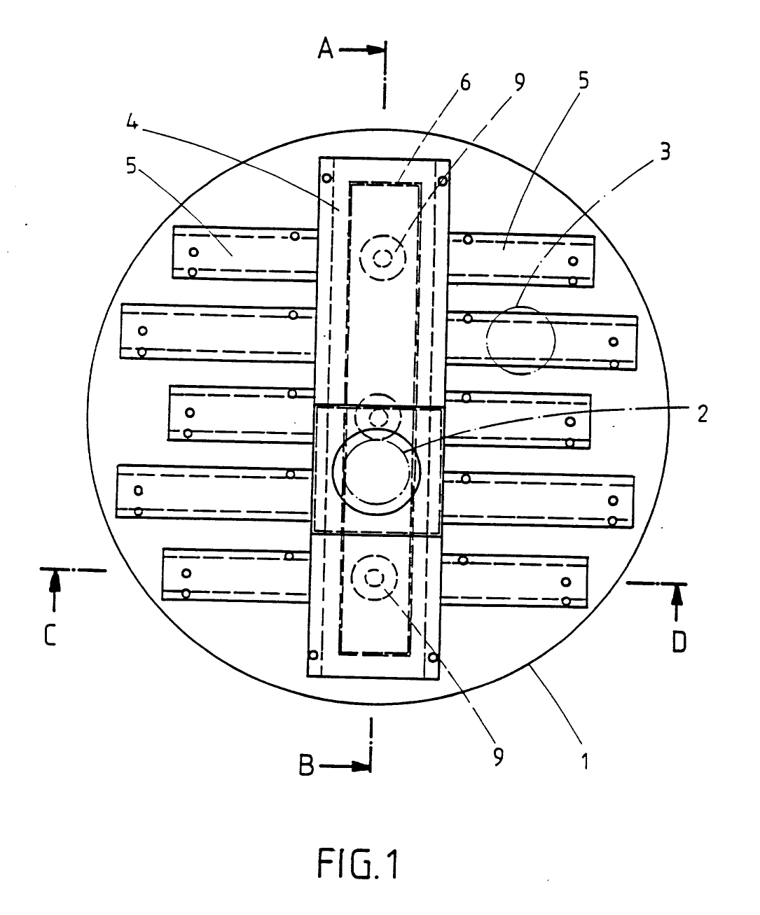

FIG. 1 is a plan view showing a distributor—adapted to a reactor with an inner wall 1—with a liquid feed pipe 2, a gas feed pipe 3, the main distributor with the main channel 4 and side channels 5 and a preliminary distributor 6 fitted into the main channel 4.

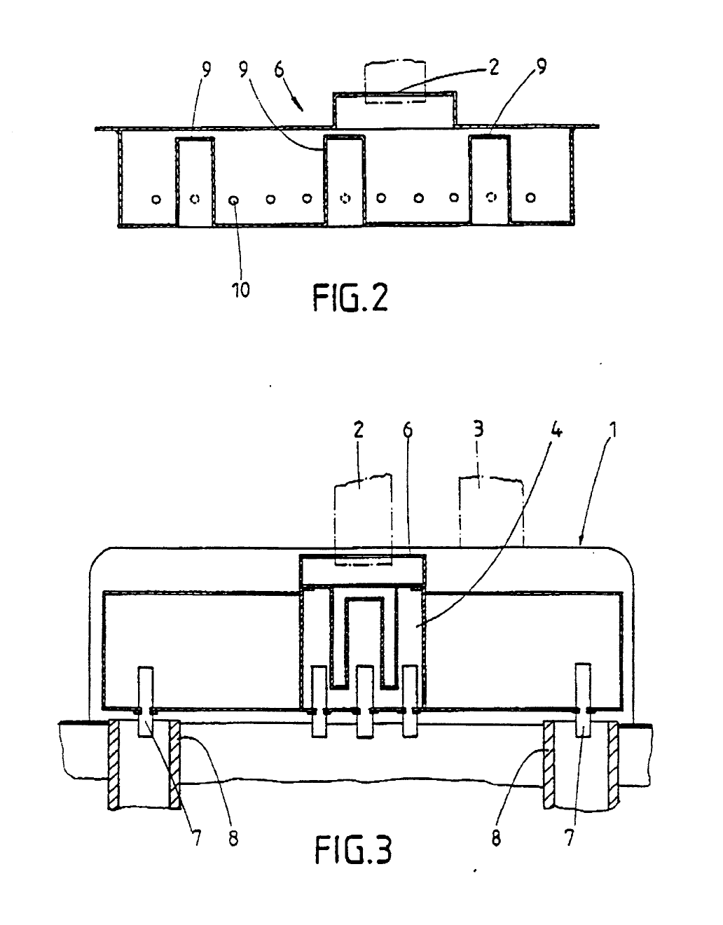

FIG. 2 is a longitudinal section through the preliminary distributor 6. As can be seen from FIGS. 2 and 3, drainage pipes 7 are provided inside the channels of the distributor, extending upwards from the bottom of the distributor and comprising inlet openings arranged above the bottom of the distributor. In this embodiment, the reactor is a tube-bundle reactor of which the reactor tubes 8 are each situated beneath a drainage pipe. To minimize the height of the distributor system, the preliminary distributor 6 is fitted into the main channel 4 of the main distributor and the bottom of the preliminary distributor 6 is guided over the drainage pipes 7 in the form of domes 9. The preliminary distributor 6 has openings 10 in its side walls through which the liquid enters the main channel 4 from the preliminary distributor 6.

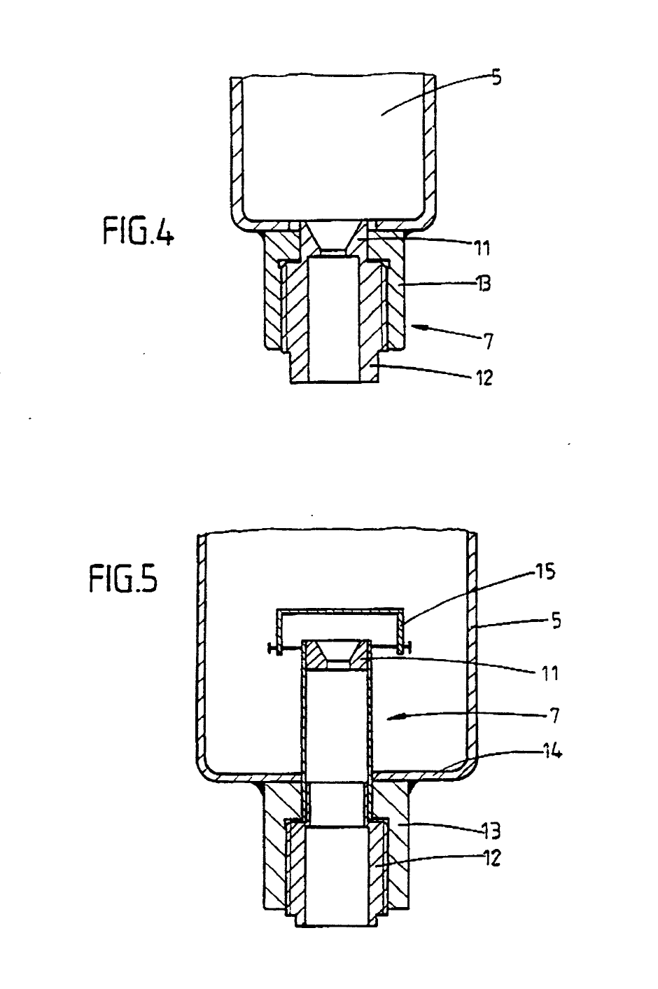

One example of embodiment of a drainage pipe 7 arranged in a side channel 5 is shown as a longitudinal section in FIG. 4. At its upper end, the drainage pipe 7 consists of a polytetrafluoroethylene insert 11 tapering downwards in the shape of a nozzle and a stainless steel pipe section 12 which is arranged beneath the insert 11 and which, through an outer screwthread, is screwed into the inner screwthread of a tubular holder 13 welded onto the underneath of the bottom of the side channel 5.

Another embodiment is shown in FIG. 5. In this case, the drainage pipe 7 extends upwards from the bottom 14 of the distributor and, in addition, comprises a hood 15 which stops the direct inflow of liquid.

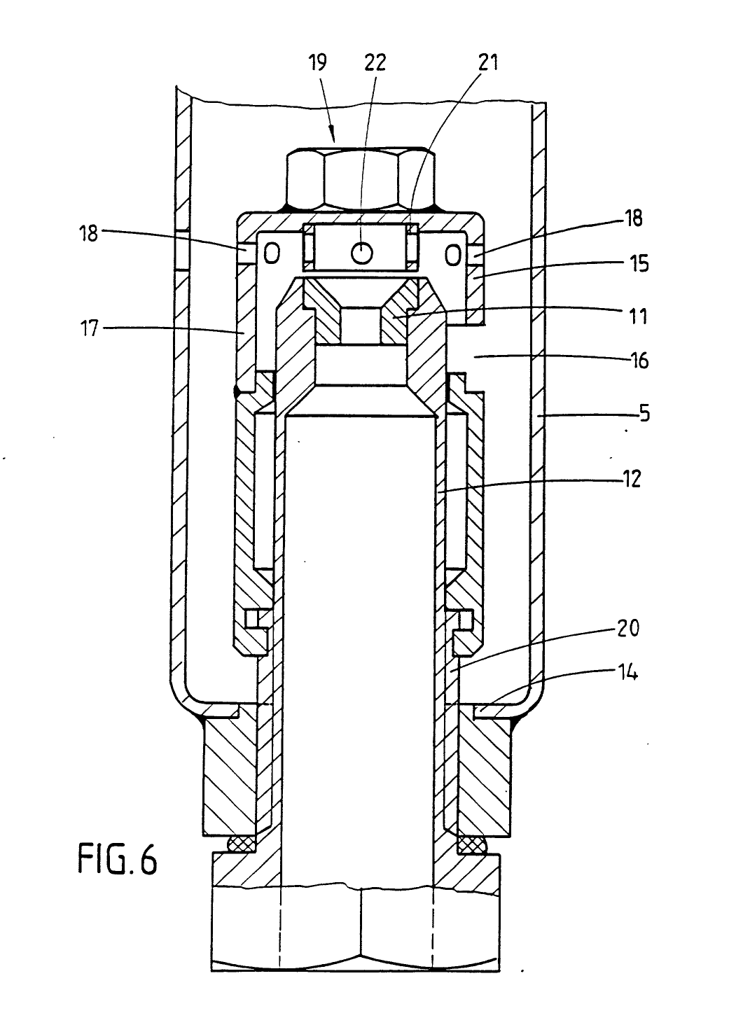

A particularly preferred embodiment of the drainage outlet is shown as a longitudinal section in FIG. 6. The nozzle-like insert 11, the pipe section 12 underneath it and the hood 15 are again provided. However, the inflow of liquid through the hood 15 to the inlet opening in the insert 11 is specially configured. One of the openings in the hood 15 is in the form of a horizontally encircling annular gap 16 with webs 17 interrupting this gap, further openings are provided in the form of bores 18 arranged in a horizontally encircling line above the annular gap and another opening is provided in the form of a bore 19 in the head of the hood 15. In this embodiment, too, the drainage pipe 12 is formed with an outer screwthread 20 which is suitable for screwing the drainage outlet into the bottom of the channel and by which the hood 15 is also secured to the pipe section 12. In addition, an annular inner wall 21 with bores 22 is provided on the inside of the hood, dividing the inner space enclosed by the hood into an outer compartment and an inner compartment. In addition, the inner wall 21 presses the insert 11 against a shoulder in the pipe section 12 and thus keeps it in position.

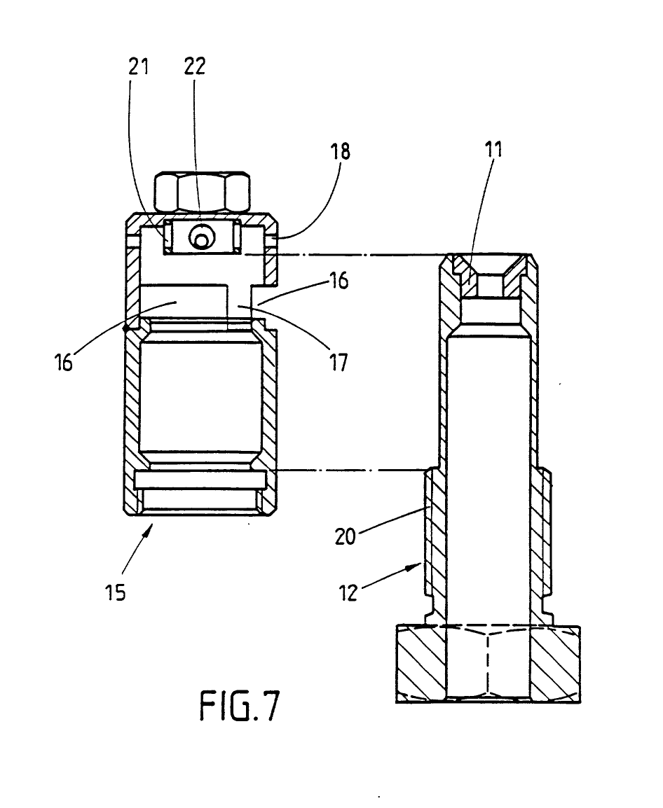

In the interests of clarity, the hood 15 and the pipe section 12 acting as a drainage pipe are shown once more in FIG. 7.

Finally, it is pointed out that the gel-like and filament-like soils present in the liquid in the processing of native oils and fats are retained in particular at the webs 17 of the hood 15 and at the openings 22 of the inner wall 21.

In all the figures, the same elements are denoted by the same reference numerals.

List of Reference Numerals

| | |
|---|---|
| 1 | Inner reactor wall |
| 2 | Liquid feed pipe |
| 3 | Gas feed pipe |
| 4 | Main channel |
| 5 | Side channel |
| 6 | Preliminary distributor |
| 7 | Drainage pipe |
| 8 | Reactor tube |
| 9 | Dome |
| 10 | Opening |
| 11 | Insert |
| 12 | Pipe section |
| 13 | Holder |
| 14 | Bottom of distributor |
| 15 | Hood |
| 16 | Annular gap |
| 17 | Web |
| 18 | Bore |
| 19 | Bore |
| 20 | Outer screwthread |
| 21 | Inner wall |
| 22 | Bore |

What is claimed is:

1. A liquid distributor said distributor being in the form of a channel distributor comprising a drainage outlet in the form of a drainage pipe having a cross-section, at the upper end of the drainage pipe, which tapers downward in the shape of a nozzle.

2. The distributor of claim 1 wherein said drainage pipe extends upwards from the bottom of the distributor and comprises an inlet opening above the bottom of the distributor.

3. The distributor of claim 2 further comprising a hood, with at least one opening, said hood covering said inlet opening of the drainage pipe against the direct inflow of liquid.

4. The distributor of claim 3 wherein one of the openings of said hood is a horizontally encircling annular gap.

5. The distributor of claim 4 wherein said annular gap is interrupted by webs between the upper and lower parts of said hood.

6. The distributor of claim 3 wherein a plurality of bores, acting as openings are arranged in a horizontally encircling line around said hood.

7. The distributor of claim 3 wherein at least one bore is in the top of said hood.

8. The distributor of claim 3 wherein the area enclosed by said hood is divided, by an annular inner wall having at least one opening, such that the inlet of said drainage pipe is situated within said annular inner wall.

9. The distributor of claim 3 wherein said nozzle-like tapering of said drainage pipe is formed by a insert arranged in said drainage pipe and with the upper edge of said insert being held in place by the inner wall of said hood.

10. The distributor of claim 3 wherein said drainage pipe comprises an external screwthread by which said drainage pipe is screwed both to the bottom of said distributor and to said hood.

11. The distributor of claim 1 wherein a preliminary distributor is fitted into the main channel of said distributor and the base of said preliminary distributor extends over the drainage pipes in the form of domes.

12. The distributor of claim 11 wherein a sieve is inserted into said preliminary distributor between the inlet and outlet.

13. The distributor of claim 1 wherein the material of construction of the inner wall of the nozzle is selected from the group consisting of metal, ceramic, graphite, plastic or a combination thereof.

14. The distributor of claim 13 wherein the inner wall of the nozzle is made of plastic.

15. The distributor of claim 1 wherein the distributor is used to distribute liquid in substantially vertical reactor with a fixed catalyst bed.

16. A method of distributing liquid in a substantially vertical reactor with a fixed catalyst bed wherein the distributor of claim 1 is used to enact even distribution of a feed liquid.

17. A method for the hydrogenation of native fats, oils, fatty acids, and fatty acid ester in a substantially vertical reactor with a fixed catalyst bed wherein the distributor of claim 1 is used to enact even distribution of a feed liquid.
